(19) United States
(12) Patent Application Publication
(10) Pub. No.: US 2023/0410285 A1
(43) Pub. Date: Dec. 21, 2023

(54) ABNORMALITY DETECTION SYSTEM, LEARNING APPARATUS, ABNORMALITY DETECTION PROGRAM, AND LEARNING PROGRAM

(71) Applicant: Konica Minolta, Inc., Tokyo (JP)

(72) Inventors: Kiichi OKUNO, Tokyo (JP); Tomoya OKAZAKI, Tokyo (JP); Takehiko SASHIDA, Tokyo (JP); Koki TACHI, Tokyo (JP)

(21) Appl. No.: 18/037,817

(22) PCT Filed: Nov. 8, 2021
(86) PCT No.: PCT/JP2021/040920

§ 371 Date: May 19, 2023

(30) Foreign Application Priority Data
Dec. 25, 2020 (JP) 2020-216488

(51) Int. Cl. G06T 7/00; G06V 10/48; G06V 10/74

(52) U.S. Cl. CPC G06T 7/001; G06V 10/48; G06V 10/761

(57) ABSTRACT

Stable determination accuracy is secured regardless of an image size, in abnormality detection of detecting a visual defect of an object. An abnormality detection system includes an input unit, a feature extractor, an image generator, and a detector. The input unit acquires inspection images of a target object, the inspection images having different image sizes each of which is equal to or more than a predetermined size. The feature extractor is previously learned to extract a feature map from training images including a non-defective image of the target object. The image generator is previously learned to restore the training images from the feature map extracted by the feature extractor. The detector compares the inspection image of the target object, which is an inspection target, the inspection image being input to the input unit, with a corresponding restored image restored from the inspection image by the feature extractor and the image generator. The inspection image has one of the different image sizes each of which is equal to or more than the predetermined size. The detector detects an abnormality of the target object, based on a calculated similarity.

### TECHNICAL FIELD

The present invention relates to an abnormality detection system, a learning apparatus, an abnormality detection program, and a learning program.

### BACKGROUND ART

As a known technique, unsupervised learning has been carried out in an autoencoder (AE) or a variational autoencoder (VAE), using training images of non-defectives. An image of an inspection target is input to a learning model resulting from the learning, and an output image from the learning model is compared with a restored image that is restored by the AE or the VAE. An abnormality of the inspection target is thus detected.

An example of this technique is an abnormality detection system disclosed in Patent Literature 1. The abnormality detection system includes a storage unit, an acquisition unit, a measurement unit, a determination unit, and a learning unit. The storage unit stores a latent variable model and a joint probability model. The acquisition unit acquires sensor data that is output by a sensor. The measurement unit measures the probability of the sensor data acquired by the acquisition unit based on the latent variable model and the joint probability model stored by the storage unit. The determination unit determines whether the sensor data is normal or abnormal based on the probability of the sensor data measured by the measurement unit. The learning unit learns the latent variable model and the joint probability model based on the sensor data output by the sensor.

In addition, another example of the foregoing technique is a visual abnormality inspection apparatus disclosed in Patent Literature 2. The visual abnormality inspection apparatus includes an image restoration and generation unit and an abnormality determination unit. The image restoration and generation unit generate a restored image in a subspace of a feature space representing a non-defective feature. The subspace of the feature space representing the non-defective feature is obtained in advance based on a feature vector extracted from each of a plurality of non-defective images representing an appearance of an inspection target that is a non-defective. The restored image is an image obtained by restoring an input inspection target image representing the appearance of the inspection target. The abnormality determination unit compares the generated restored image with the inspection target image to detect a visual abnormality of the inspection target.

### CITATION LIST

### Patent Literature

Patent Literature 1: JP 2020-119605 A
Patent Literature 2: JP 2017-219529 A

### SUMMARY OF INVENTION

### Technical Problem

However, Patent Literatures 1 and 2 each have no description about an image size of an inspection image to be input. According to the techniques disclosed in Patent Literatures 1 and 2, therefore, it is considered that an inspection image to be input has a certain image size. In a case of inputting an image having a certain image size, when an inspection image having an image size other than an optimized prescribed image size is input, there is a possibility that accuracy of a determination as to a non-defective or a defective cannot be secured. For example, in a case of inputting an inspection image having a size larger by several times than the prescribed image size, the inspection image is subjected to preprocessing of resizing the size of the inspection image to the prescribed image size, and then is input to an AE. In this case, information required for a determination is lost from the inspection image before being input to the AE. Consequently, accuracy of the determination is deteriorated.

The present invention has been made in view of the foregoing circumstances. That is, an objective of the present invention is to secure stable determination accuracy regardless of an image size, in detecting a visual defect of an object. Provided are an abnormality detection system, a learning apparatus, an abnormality detection program, and a learning program for achieving this objective.

### Solution to Problem

The foregoing objective of the present invention is achieved by the following solutions.
(1) An abnormality detection system for detecting a visual defect of an object,
the abnormality detection system including:
an input unit that acquires inspection images of a target object, the inspection images having different image sizes each of which is equal to or more than a predetermined size;
a feature extractor that is previously learned to extract a feature map from training images including a non-defective image of the target object;
an image generator that is previously learned to restore the training images from the feature map extracted by the feature extractor; and
a detector that detects an abnormality of the target object, based on a similarity calculated by comparing the inspection image of the target object which is an inspection target, the inspection image being input to the input unit and having one of the different image sizes each of which is equal to or more than the predetermined size, with a corresponding the restored image restored from the inspection image by the feature extractor and the image generator.
(2) The abnormality detection system as recited in (1) above, in which
the detector is set to detect the abnormality of the target object at a degree of accuracy equal to or more than a certain level, regardless of the image sizes of the inspection image input to the input unit.
(3) The abnormality detection system as recited in (1) or (2) above, in which
the feature map extracted by the feature extractor has a size equal to or more than a size of 8 by 8 pixels.
(4) The abnormality detection system as recited in (3) above, in which
on condition that the sizes of the inspection image are indicated by M and the size of the feature map is indicated by N, the feature map extracted by the feature extractor satisfies the following formula (1):

N≥M×(½)\hat{ }^{a} Formula (1),
where M and N each represent a number of lengthwise or widthwise pixels, and a represents a number of convolution layers in the feature extractor.
(5) The abnormality detection system as recited in (3) or (4) above, in which
the size of the feature map extracted by the feature extractor is proportional to the sizes of the inspection image input to the input unit.
(6) The abnormality detection system as recited in any one of (1) to (5) above, in which
the feature extractor extracts the feature map from which spatial information on an image is not lost.
(7) The abnormality detection system as recited in (6) above, in which
the feature extractor does not include a fully connected layer or a global average pooling (GAP) layer.
(8) The abnormality detection system as recited in any one of (1) to (7) above, in which
the feature extractor and the image generator each have a structure to be changed in accordance with the sizes of the input inspection image.
(9) The abnormality detection system as recited in any one of (1) to (8) above, in which
the inspection image is image of an electronic circuit.
(10) A learning apparatus for learning a learning model that carries out abnormality detection of detecting a visual defect of an object,
the learning model including a feature extractor and an image generator,
the learning apparatus including:
an input unit that acquires training images including a non-defective image of a target object;
the feature extractor that extracts a feature map, based on the training images input to the input unit;
the image generator that generates restored image by restoring the training images from the feature map extracted by the feature extractor; and
a learning unit that updates parameters of the feature extractor and image generator, based on the training images and the restored images,
in which
the training images input to the input unit have different image sizes each of which is equal to or more than a predetermined size.
(11) The learning apparatus as recited in (10) above, in which
the feature map extracted by the feature extractor has a size equal to or more than a size of 8 by 8 pixels.
(12) The learning apparatus as recited in (11) above, in which
on condition that the sizes of the training images are each indicated by M and the size of the feature map is indicated by N, the feature map extracted by the feature extractor satisfies the following formula (1):

N≥M×(½)\hat{ }^{a} Formula (1),
where M and N each represent a number of lengthwise or widthwise pixels, and a represents a number of convolution layers in the feature extractor.
(13) The learning apparatus as recited in any one of (10) to (12) above, in which
the feature extractor extracts the feature map from which spatial information on an image is not lost.
(14) The learning apparatus as recited in (13) above, in which
the feature extractor does not include a fully connected layer or a global average pooling (GAP) layer.
(15) An abnormality detection program for causing a computer to function as the abnormality detection system as recited in any one of (1) to (9) above.
(16) A learning program for causing a computer to function as the learning apparatus as recited in any one of (10) to (14) above.

### Advantageous Effects of Invention

In the present invention, an abnormality detection system includes an input unit, a feature extractor, an image generator, and a detector. The input unit acquires inspection images of a target object, the inspection images having different image sizes each of which is equal to or more than a predetermined size. The feature extractor is previously learned to extract a feature map from training images including a non-defective image of the target object. The image generator is previously learned to restore the training images from the feature map extracted by the feature extractor. The detector compares the inspection image of the target object which is an inspection target, the inspection images being input to the input unit, with a corresponding the restored image restored from the inspection image by the feature extractor and the image generator. The inspection image has one of the different image sizes each of which is equal to or more than the predetermined size. The detector detects an abnormality of the target object, based on a calculated similarity. This configuration thus secures stable determination accuracy regardless of an image size.

### BRIEF DESCRIPTION OF DRAWINGS

FIG. 1 is a diagram illustrating a configuration of an abnormality detection system.

FIG. 2 is a block diagram of the abnormality detection system.

FIG. 3 is a functional block diagram of a controller of the abnormality detection system in learning.

FIG. 4 is a schematic diagram illustrating an exemplary configuration of the controller in learning.

FIG. 5 is a flowchart illustrating learning processing executed in the abnormality detection system.

FIG. 6 is a functional block diagram of the controller of the abnormality detection system in abnormality detection.

FIG. 7 is a schematic diagram illustrating an exemplary configuration of the controller in abnormality detection.

FIG. 8 is a flowchart illustrating abnormality detection processing in the abnormality detection system.

FIG. 9 is a schematic diagram illustrating a relationship between a size of a feature map and restoration accuracy.

### DESCRIPTION OF EMBODIMENTS

With reference to the attached drawings, the following describes embodiments of the present invention. In the drawings, the same elements are denoted by the same reference sign; therefore, the redundant description thereof will not be given. Also in the drawings, some dimensional ratios are exaggerated for convenience of the illustration and are therefore different from actual ones.

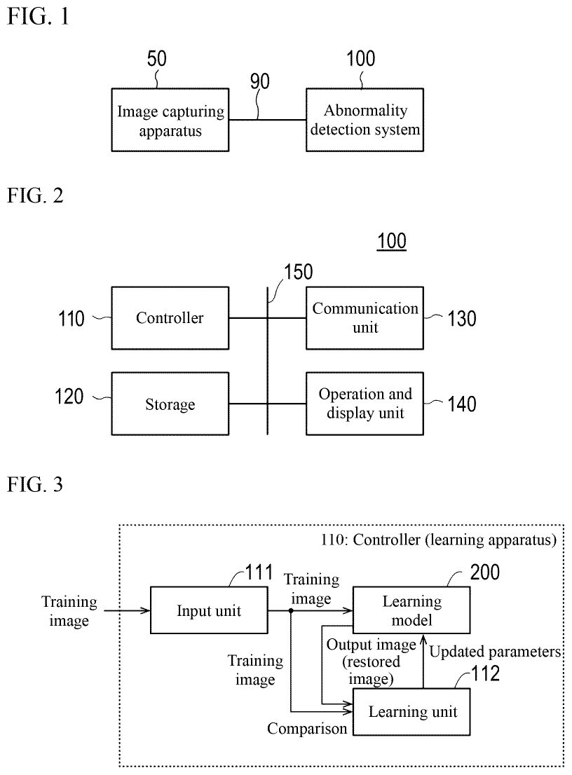

FIG. 1 is a diagram illustrating a configuration of an abnormality detection system 100. FIG. 2 is a block diagram of the abnormality detection system 100. As illustrated in FIG. 1, the abnormality detection system 100 is connected to an image capturing apparatus 50 via a network 90 or a cable. The image capturing apparatus 50 may be incorporated in the configuration of the abnormality detection system 100. The abnormality detection system 100 functions as a learning apparatus in learning.

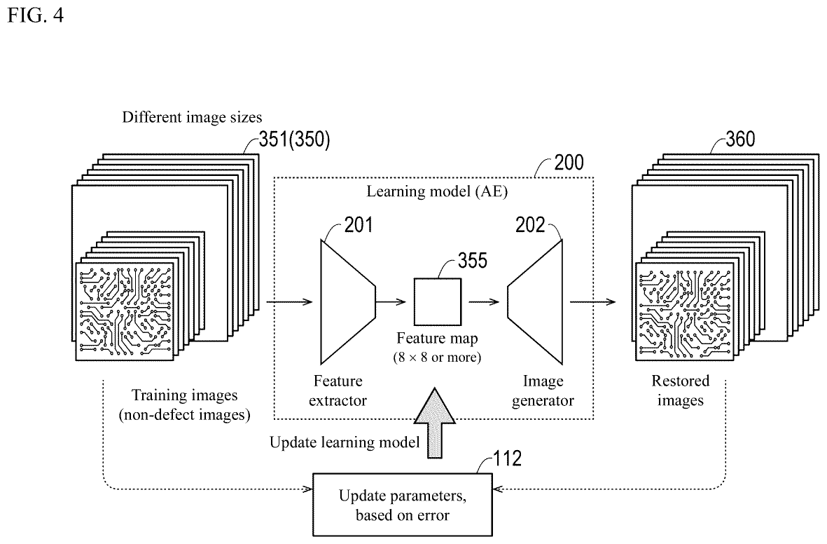

The image capturing apparatus 50 captures an image of an object to be subjected to an inspection (hereinafter, referred to as an inspection target) to generate image data, and outputs the image data. As illustrated in FIG. 4, the image data is also an inspection image 350 of the inspection target or a training image 351 as will be described later. The image capturing apparatus 50 is practicable using, for example, a camera. The inspection target is, for example, a predetermined product Examples of the product include circuit boards and other electronic circuits, and components such as bolts and nuts. The inspection involves screening of a defective through detection of an abnormality such as a fold, a bend, a chip, a scratch, or a stain. The inspection may involve only detection of a position or the like of an abnormality such as a fold, a bend, a chip, a scratch, or a stain.

The image capturing apparatus 50 captures an image of an area covering the inspection target, and outputs the captured image. The captured image is output as image data. The image capturing apparatus 50 may output captured images having different image sizes.

For example, the captured image is a black-and-white or color image. The captured image may be an SD image having an image size of 720 by 480 pixels. The captured image may be an HD image having an image size of 1920 by 1080 pixels. The captured image may be a 4K image having an image size of 3840 by 2160 pixels. The image size is represented by the number of pixels. The captured image may be changed to an image having an image size of 512 by 512 pixels or 1024 by 1024 pixels, by trimming, compression, or the like. From the viewpoint of processing speed, preferably, the maximum image size is set at 2000 by 2000 pixels, and the captured image has an image size equal to or less than the image size of 2000 by 2000 pixels when being input. The image capturing apparatus 50 transmits the generated captured image to the abnormality detection system 100.

As illustrated in FIG. 2, the abnormality detection system 100 includes a controller 110, a storage 120, a communicator 130, and an operation and display unit 140. These constituent elements are connected to each other via a bus 150. The abnormality detection system 100 is practicable using, for example, a computer terminal. Note that the abnormality detection system 100 may be an on-premise server. The abnormality detection system 100 may alternatively be a cloud server utilizing a commercially available cloud service.

The controller 110 includes a CPU and memories such as a RAM and a ROM. The CPU is an abbreviation for “central processing unit”. The RAM is an abbreviation for “random access memory”. The ROM is an abbreviation for “read only memory”. The controller 110 controls each constituent element of the abnormality detection system 100 and performs computation processing, in accordance with a program. The function of the controller 110 will be described in detail later.

The storage 120 is practicable using a hard disc drive (HDD), a solid state drive (SSD), or the like. The storage 120 stores various kinds of programs and various kinds of data. The storage 120 stores a learning model learned by machine learning. The learning model is a learning model 200 which will be described later. The storage 120 may further store a training image to be used for learning.

The communicator 130 is an interface circuit for communicating with an external apparatus via a network. The interface circuit is, for example, a LAN card or the like. The communicator 130 receives the captured image generated by the image capturing apparatus 50. The communicator 130 sends the received captured image to an input unit 111 (to be described later) or the storage 120.

The operation and display unit 140 may be practicable using, for example, a touch screen, a liquid crystal display, and a signal tower. The operation and display unit 140 accepts various kinds of user's inputs. The operation and display unit 140 displays a result of the inspection on the inspection target.

### (Learning Processing)

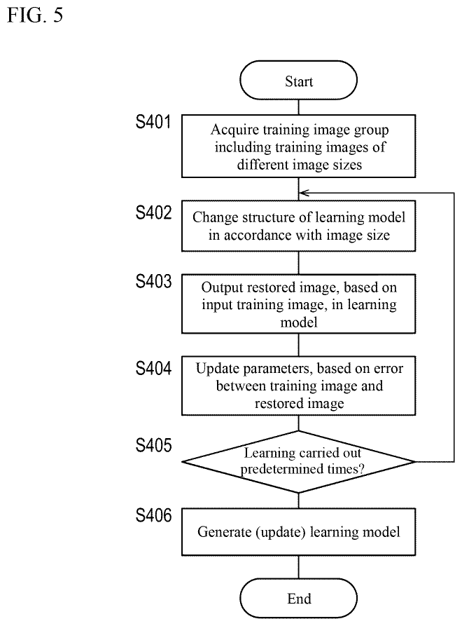

With reference to FIGS. 3 to 5, the following describes the learning function of the controller 110. FIG. 3 is a functional block diagram illustrating the function of the controller 110 of the abnormality detection system 100 in learning. FIG. 4 is a schematic diagram illustrating an exemplary configuration of the controller 110 in learning. FIG. 5 is a flowchart illustrating learning processing in the abnormality detection system 100. As described above, the abnormality detection system 100 functions as the learning apparatus in learning.

As illustrated in FIG. 3, the controller 110 functions as the input unit 111 and a learning unit 112. The input unit 111 is capable of acquiring captured images of different sizes. The captured images are training images or inspection images. The learning unit 112 carries out learning with the training images input to the input unit 111 and generates a learning model. The training images to be used for learning in the abnormality detection system 100 are captured images of a plurality of normal inspection targets. The training images are learning data. The captured images are image data. For simplification of the description, the term “training images 351” as used herein refer to the image data on the captured images of the normal inspection targets. The normal target objects are non-defectives. The target objects are, for example, electronic circuits or circuit boards.

For the learning in the abnormality detection system 100, a training image group including the plurality of training images 351 is used as input data. A learning model 200 configured with an autoencoder or a variational autoencoder is generated.

As illustrated in FIG. 4, the learning model 200 is a model of a neural network and includes a feature extractor 201 and an image generator 202. The feature extractor 201 is also referred to as an encoder. The image generator 202 is also referred to as a decoder. The feature extractor 201 extracts a feature map 355 through computations for the input data in a plurality of convolution layers and a pooling layer. The feature extractor 201 outputs the feature map 355 to the image generator 202. The image generator 202 restores and outputs the input data. The term “pooling layer” refers to a maximum pooling layer or an average pooling layer. The same applies to the following. In learning, the training images 351 are input to the learning model 200. Learning is carried out by back propagation to eliminate a difference (a loss) between the training images 351 and restored images 360 to be output from the learning model 200. In this way, the learning unit 112 generates or updates a learning model.

The feature extractor 201 as an encoder includes the plurality of convolution layers and the pooling layer. The pooling layer is, for example, a maximum pooling layer. For example, maximum pooling is carried out in a 2 by 2 pixel area. The feature extractor 201 does not include a fully connected layer or a global average pooling (GAP) layer. According to this configuration, the feature map 355 extracted based on the input captured images holds spatial information on the captured images without a possibility that the spatial information is lost.

The feature extractor 201 extracts the feature map 355 having a size equal to or more than a size of 8 by 8 pixels, regardless of an image size of a captured image input thereto. For this configuration, the feature extractor 201 is set to extract a feature map 355 having a size equal to or more than the size of 8 by 8 pixels in learning.

In addition, the size of the feature map 355 extracted by the feature extractor 201 is proportional to the size of the input captured image and is set to satisfy the following formula (1).

N≥M×(½)\hat{ }^{a} Formula (1)

In the formula (1), M represents a lengthwise or widthwise size (the number of pixels) of an inspection image 350 or a training image 351. Also, in the formula (1), N represents a lengthwise or widthwise size of a feature map. Also, in the formula (1), a represents the number of convolution layers in the feature extractor 201. The size of the feature map 355 is set to satisfy the formula (1) since it is necessary to abstract information through convolution processing before down-sampling of a captured image input to the feature extractor 201. If failing to abstract the information, there is a possibility that characteristic information on a non-defective image is lost in the down-sampling.

The feature extractor 201 and the image generator 202 may have a structure changeable in accordance with the image size of the input captured image. A change in the structure is, for example, a change in the number of strides, a change in the number of convolution layers or deconvolution layers, or the like. Examples of the structure include structures 1 to 3 to be described later.

The image generator 202 has a configuration corresponding to the configuration of the feature extractor 201. That is, the image generator 202 has an inverted configuration relative to the configuration of the feature extractor 201. For example, the image generator 202 includes a plurality of deconvolution layers and an unpooling layer respectively corresponding to the plurality of convolution layers and the pooling layer in the feature extractor 201. The unpooling layer is also referred to as an up-sampling layer. A captured image to be input to the feature extractor 201 is equal in size to a restored image 360 to be output from the image generator 202.

With reference to FIG. 5, the following describes the operation of the abnormality detection system 100 functioning as the learning apparatus in learning. The controller 110 of the abnormality detection system 100 executes processing illustrated in the flowchart of FIG. 5, in accordance with a program.

### (Step S401)

The input unit 111 acquires a training image group including a plurality of training images 351 from the image capturing apparatus 50 via the communicator 130. Alternatively, the training image group is temporarily accumulated in the storage 120 in advance. The input unit 111 then acquires the training image group. The training images 351 included in the training image group have different image sizes each of which is equal to or more than a predetermined size. The predetermined size is equal to or more than a size of 512 by 512 pixels. More preferably, the predetermined size is equal to or more than a size of 1024 by 1024 pixels. In order to increase the number of training images 351 as samples, the training images 351 for use in a learning model 200 may be subjected to various kinds of processing by the input unit 111. The various kinds of processing include trimming of cutting a part of each training image 351, rotation, flipping or mirroring, and the like.

### (Step S402)

The controller 110 selects a learning model 200 having a structure that differs in accordance with the image sizes of the training images 351 to be used for training. For example, one of the following structures 1 to 3 is applicable.

### (Structure 1)

A different structural element is the number of strides. All the kernels (filters) are used in common. The number of strides is set to increase as an image size is larger. In this case, other structures, such as the number of layers, a kernel size, and a padding value, are the same.

### (Structure 2)

A different structural element is the number of layers. Some of the kernels are used in common. Specifically, the number of convolution layers or deconvolution layers is set to differ in accordance with an image size. When the image size is larger than the predetermined size, the number of layers increases. In this case, the same kernels are used in common with regard to the layers that are equal in number to each other. In other words, layers are added prior to or subsequent to an encoder and a decoder for small sizes.

### (Structure 3)

A different structural element is the number of layers. The kernels are not used in common. Specifically, a plurality of learning models that are different in number of layers and kernel from each other are selectively used in accordance with an image size. The plurality of learning models are subjected to the following training independently of each other.

### (Step S403)

In the learning model 200 selected in step S402, the feature extractor 201 receives the training images 351, and extracts a feature map 355. The image generator 202 then outputs restored images 360.

### (Step S404)

The learning unit 112 updates parameters of the learning model 200, based on an error between each training image 351 input in step S403 and corresponding restored image 360 output in step S403. The learning model 200 includes the feature extractor 201 and the image generator 202. Specifically, the learning unit 112 acquires a difference between each training image 351 and corresponding restored image 360, and updates the parameters of the learning model 200 so as to reduce an error between the training image 351 and the restored image 360.

### (Step S405)

When the learning is carried out predetermined times (YES), the controller 110 causes the processing to proceed to step S406. For example, when the learning for all the training images 351 included in the training image group ends, the controller 110 causes the processing to proceed to step S406. When the learning is not completed, the controller 110 causes the processing to return to step S402, and repeats the learning with a next one of the training images 351.

### (Step S406)

The controller 110 causes the storage 120 to store the learning model 200 generated or updated through the machine learning, and then ends the learning processing (END).

### (Abnormality Detection Processing)

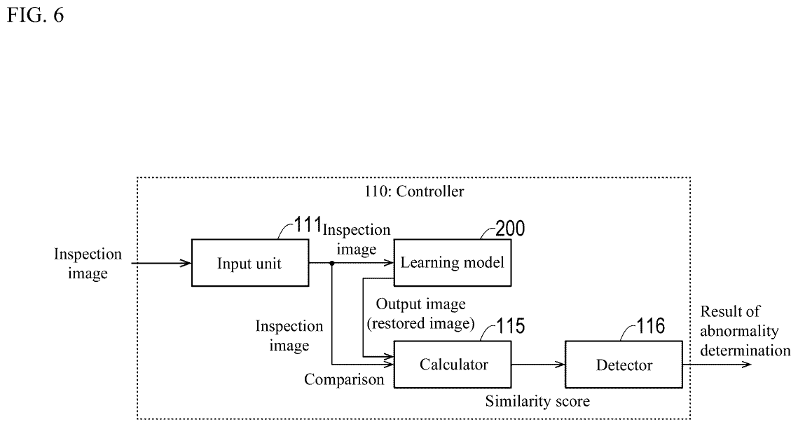

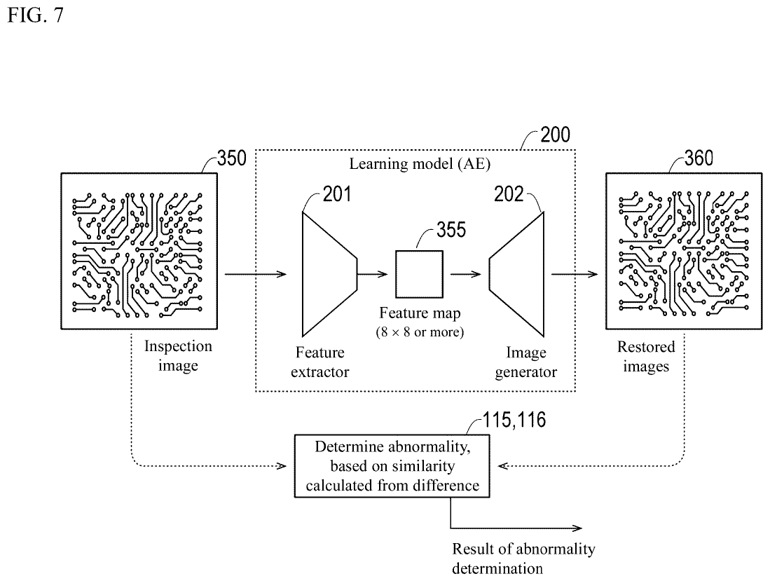

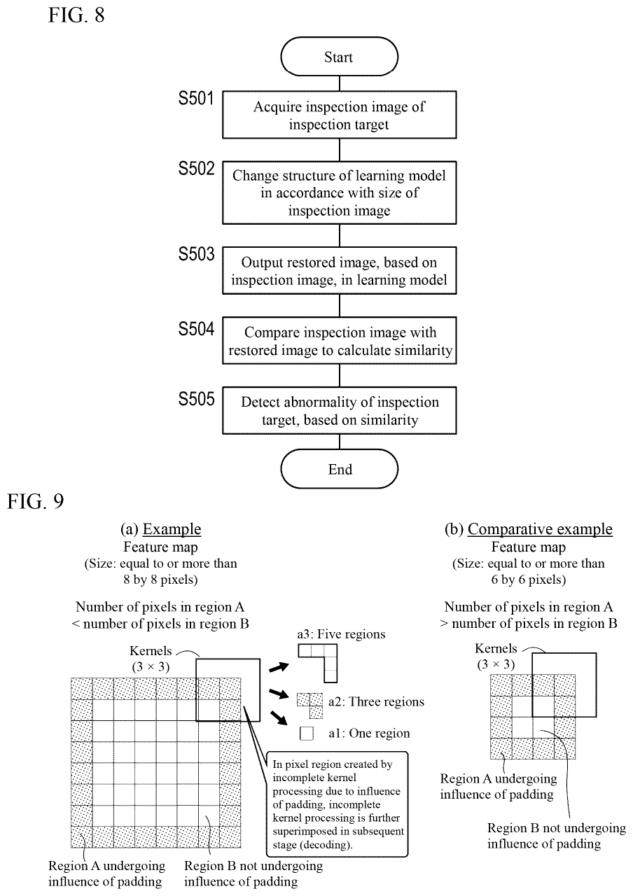

With reference to FIGS. 6 to 8, the following describes abnormality detection processing to be executed using the learning model 200 generated through the foregoing learning processing. FIG. 6 is a functional block diagram of the controller 110 of the abnormality detection system 100 in abnormality detection. FIG. 7 is a schematic diagram illustrating an exemplary configuration of the controller 110. FIG. 8 is a flowchart illustrating the abnormality detection processing.

As illustrated in FIGS. 6 and 7, the controller 110 functions as the input unit 111, a calculator 115, and a detector 116.

The input unit 111 acquires a captured image from the image capturing apparatus 50 via the communicator 130, in a manner similar to that in the foregoing learning. The captured image is obtained in such a manner that the image capturing apparatus 50 captures an image of a target object which is an actual inspection target. In the following, the captured image of the inspection target is referred to as an “inspection image” or an “inspection image 350”.

As illustrated in FIGS. 6 and 7, the learning model 200 outputs a restored image 360, based on the input inspection image 350. In the learning model 200, the feature extractor 201 as an encoder generates a feature map 355 in the course of the learning processing. The feature map 355 is set to have a size equal to or more than the size of 8 by 8 pixels even in a case where the input inspection image has a large image size. The feature map 355 is set to have a size equal to or more than the size of 8 by 8 pixels by changing the structure (e.g., one of the structures 1 to 3) of the learning model 200 as described above.

The feature map 355 is set so as to have a size proportional to the image size of the input inspection image. In the present embodiment, the inspection image is input to the input unit 111 without being resized to a certain image size. The certain image size is, for example, a size of 256 by 256 pixels or a size of 512 by 512 pixels. For example, the inspection image is input in its original size. The feature map 355 is extracted to have a size proportional to the image size of the input inspection image. In this case, the inspection image may be resized step by step in accordance with its image size. Alternatively, an upper limit may be set for an image size of an input image, and an inspection image having a size more than the upper limit may be resized to a size within the upper limit. For example, the upper limit is set at 2000 pixels. In this case, a captured image having an image size equal to or less than the image size of 2000 by 2000 pixels is input as it is. A captured image having an image size of which the number of lengthwise or widthwise pixels is more than 2000 is resized as a whole such that the number of lengthwise or widthwise pixels exceeding 2000 is reduced to 2000 or less.

The feature extractor 201 as an encoder includes the plurality of convolution layers and the pooling layer. However, the feature extractor 201 does not include the fully connected layer or the global average pooling layer. As a result, the size of the feature map 355 obtained based on the input inspection image 350 becomes smaller than the inspection image 350 through the processing by the feature extractor 201. However, the feature map 355 holds spatial information on the inspection image 350 without the loss of the spatial information.

Furthermore, the size of the feature map 355 extracted by the feature extractor 201 is proportional to the size of the input inspection image 350. In addition, by using the learning model 200 learned as described above, the size of the feature map 355 is equal to or more than the size of 8 by 8 pixels. The size of the feature map 355 also satisfies the foregoing formula (1).

The calculator 115 calculates a similarity between restoration data output from the learning model 200 and the inspection image that is a source of the restoration data. For example, the calculator 115 calculates and outputs, as the similarity, an absolute value of a difference between the restoration data and each pixel value of the inspection image. The calculator 115 may calculate, as the similarity, a root mean square of the absolute value of the difference between the restoration data and each pixel value of the inspection image. The calculator 115 may calculate the similarity between the restoration data and the inspection image by a known method such as an SSIM or a cosine distance. The similarity may be output as a score.

The detector 116 detects an abnormality in the inspection image, based on the similarity calculated by the calculator 115, and outputs a result of the detection. For example, the detector 116 may determine that a pixel portion of the inspection image, in which an absolute value of a difference between the restoration data and its pixel value is equal to or more than a predetermined threshold value, is abnormal or defective, and thus determine that the inspection image is abnormal. The detector 116 may determine that an inspection image in which a root mean square of an absolute value of a difference between restoration data and each pixel value of a product image is equal to or more than a predetermined threshold value is abnormal. The detector 116 may determine that a product image, in which a similarity between the restoration data and the inspection image calculated by a known method such as an SSIM or a cosine distance is less than a predetermined threshold value, is abnormal. These threshold values may be appropriately set by experiment from the viewpoint of the abnormality detection accuracy of the abnormality detection system 100.

With reference to FIG. 8, the following describes the operation of the abnormality detection system 100 in abnormality detection. The controller 110 of the abnormality detection system 100 executes processing illustrated in the flowchart of FIG. 8, in accordance with a program.

### (Step S501)

The input unit 111 acquires captured images (inspection images 350) of the inspection target from the image capturing apparatus 50 or the like. The inspection images 350 have different image sizes each of which is equal to or more than a predetermined size. The predetermined size is equal to or more than a size of 512 by 512 pixels, more preferably equal to or more than a size of 1024 by 1024 pixels.

### (Step S502)

The controller 110 changes the structure of the learning model 200 in accordance with the image sizes of the inspection images 350. For example, the controller 110 changes the structure of the learning model to any one of the foregoing structures 1 to 3. For example, the controller 110 reads a learning model 200 having the structure 1 of which the different structural element is the number of strides or a learning model 200 having the structure 2 or 3 of which the different structural element is the number of layers, from the storage 120, and uses the learning model 200 thus read.

### (Step S503)

The controller 110 inputs the inspection images 350 to the feature extractor 201 in the learning model 200 of which the structure has been changed. In the controller 110, the feature extractor 201 extracts a feature map 355, and the image generator 202 outputs restored images 360.

### (Step S504)

The calculator 115 calculates a similarity between each restored image 360 obtained in step S503 and the original inspection image 350. The similarity is output as a score.

### (Step S505)

The detector 116 detects an abnormality in the inspection image, that is, an abnormality of the target object, which is the subject of the inspection image, based on the similarity obtained in step S504, and outputs a result of the determination.

### (Advantageous Effects of Embodiment)

In the present embodiment, an abnormality is detectable at a certain degree of detection accuracy, regardless of an image size of an input image, as will be described below. That is, the feature extractor 201 as an encoder, when generating a feature map 355, holds spatial information on an image without converting the spatial information into vector information. The feature extractor 201 is capable of suppressing an influence of padding by setting the size of the feature map 355 at a size equal to or more than the size of 8 by 8 pixels. FIG. 9 is a schematic diagram illustrating the relationship between a size of a feature map and restoration accuracy. The feature map has an outer region which is a region A that undergoes an influence of padding. The outer region of the feature map is hatched in FIG. 9. The padding value is 1. A region inside the outer region is a region B that does not undergo an influence of padding or is less likely to undergo the influence of padding. The region B is used for reconstructing or restoring the information in a spatial direction as intended. The region A is created by incomplete kernel processing due to the influence of padding. In the region A, incomplete kernel processing is further superimposed in the subsequent decoding. For example, as illustrated in FIG. 9, in a case where convolution processing is executed by 3 by 3 kernels, the pixels at the right end are subjected to computation processing in a region a1, a region a2, and a region a3. The region a1 corresponds to one pixel that does not undergo the influence of padding. The region a2 corresponds to three pixels that undergo the influence of padding. The region a3 corresponds to five pixels added by padding. In the region A, since the number of pixels in the regions a2 and a3, used for calculation, is large, the incompleteness increases.

As illustrated in (a) of FIG. 9, in a case where the size of the feature map is equal to or more than the size of 8 by 8 pixels, the number of pixels in the region A is smaller than the number of pixels in the region B. In a case where the size of the feature map is equal to or less than a size of 6 by 6 pixels, conversely, the number of pixels in the region A is larger than the number of pixels in the region B. For example, the following describes a case where the feature map having the size of 8 by 8 pixels is subjected to padding of which the padding value is “1” in the convolution processing. In this case, 36 (6×6) pixels in the region B, which do not undergo the influence of padding, other than the outermost pixels are secured. That is, 36 (6×6) pixels capable of reconstructing the information in the spatial direction as intended are secured. In this case, the number of pixels in the region B is larger than the number (28) of pixels in the region A, and the number of pixels in the region B, which are capable of reconstructing the information in the spatial direction as intended, is dominant.

With reference to (b) of FIG. 9, the following describes a comparative example in which no restriction is imposed with regard to a pixel spatial direction and a feature map has a size less than the size of 8 by 8 pixels. For example, the feature map has a size of 4 by 4 pixels, and is divided into 16 regions. In this case, latent variables corresponding to 16 regions in a target image are inferred by one time of learning. Then, at the time of inference (detection), the region of the original image referred to at the time of feature learning is not referred to, and accurate reconstruction is not performed. With reference to (b) of FIG. 9, in addition, the following describes a case where a feature map has a size less than the size 8 of 8 pixels is obtained to satisfy a condition that the number of pixels in the region A is larger than the number of pixels in the region B. For example, in the case of a feature map having a size of 6 by 6 pixels, information is significantly lost due to compression (dimensionality reduction) by an encoder. Therefore, it is confirmed that a non-defective image is not reconstructed well in a restored image 360, resulting in deterioration of detection accuracy in the foregoing abnormality determination. According to the present embodiment, increasing the size of the feature map enables dense learning in the pixel spatial direction, and avoids the situation described in the comparative example.

In a case where an inspection image 350 has a large image size, a feature map 355 having a size of 8 by 8 pixels causes deterioration of detection accuracy in the abnormality determination since the information is significantly lost due to compression. For example, the detection accuracy is deteriorated in a case where the image size of the inspection image 350 is equal to or more than a size of 1000 by 1000 pixels. In view of this, according to the present embodiment, a feature map 355 having a size proportional to an image size of an input image is extracted. That is, the input unit 111 charges the input image into the learning model 200 as it is without changing the image size of the input image. In other words, the input unit 111 charges the input image into the learning model 200 as it is without resizing the input image to a predetermined size. The feature map 355 having the size proportional to the size of the input image is obtained and the restored image 360 is obtained. With this configuration, according to the present embodiment, an abnormality is detected at a degree of accuracy equal to or more than a certain level, regardless of an image size of an image input to the input unit 111.

Regarding the configuration of the abnormality detection system 100 described above, the main configuration has been described for describing the features of the foregoing embodiment. The configuration of the abnormality detection system 100 is not limited to the foregoing configuration and may be modified in various manners within the scope of the claims. Furthermore, a configuration of a general abnormality detection system 100 is not excluded.

Means and methods for executing various kinds of processing in the abnormality detection system 100 or the learning apparatus according to the foregoing embodiment can also be implemented by a dedicated hardware circuit. Alternatively, the means and methods for executing the various kinds of processing can also be implemented by a programmed computer. The foregoing programs including an abnormality detection program and a learning program may be provided with, for example, a computer-readable recording medium such as a USB memory or a digital versatile disc (DVD)-ROM. The foregoing programs may be provided online via a network such as the Internet. In this case, the programs recorded on the computer-readable recording medium are usually transferred to and stored in a storage such as a hard disk. Alternatively, the foregoing programs may be provided as single application software or may be incorporated, as a function of an apparatus, in software of the apparatus.

This application is based on a Japanese patent application (Japanese Patent Application No. 2020-216488) filed on Dec. 25, 2020, the disclosure of which is incorporated herein by reference in its entirety.

### REFERENCE SIGNS LIST

100 abnormality detection system
110 controller
111 input unit
112 learning unit
115 calculator
116 detector
200 learning model
201 feature extractor
202 image generator
120 storage
130 communicator
140 operation and display unit
50 image capturing apparatus
350 inspection image
351 training image
355 feature map
360 restored image

1. An abnormality detection system for detecting a visual defect of an object,
the abnormality detection system comprising:
an input unit that acquires inspection images of a target object, the inspection images having different image sizes each of which is equal to or more than a predetermined size;
a feature extractor that is previously learned to extract a feature map from training images including a non-defective image of the target object;
an image generator that is previously learned to restore the training images from the feature map extracted by the feature extractor; and
a detector that detects an abnormality of the target object, based on a similarity calculated by comparing inspection image of the target object which is an inspection target, the inspection image being input to the input unit and having one of the different image sizes each of which is equal to or more than the predetermined size, with a corresponding the restored image restored from the inspection image by the feature extractor and the image generator.

2. The abnormality detection system according to claim 1, wherein
the detector is set to detect the abnormality of the target object at a degree of accuracy equal to or more than a certain level, regardless of the image sizes of the inspection image input to the input unit.

3. The abnormality detection system according to claim 1, wherein
the feature map extracted by the feature extractor has a size equal to or more than a size of 8 by 8 pixels.

4. The abnormality detection system according to claim 3, wherein
on condition that the sizes of the inspection image are indicated by M and the size of the feature map is indicated by N, the feature map extracted by the feature extractor satisfies the following formula (1):
N≥M×(½)\hat{ }^{a} Formula (1),
where M and N each represent a number of vertical or horizontal pixels, and a represents a number of convolution layers in the feature extractor.

5. The abnormality detection system according to claim 3, wherein
the size of the feature map extracted by the feature extractor is proportional to the sizes of the inspection image input to the input unit.

6. The abnormality detection system according to claim 1, wherein
the feature extractor extracts the feature map from which spatial information on an image is not lost.

7. The abnormality detection system according to claim 6, wherein
the feature extractor does not include a fully connected layer or a global average pooling (GAP) layer.

8. The abnormality detection system according to claim 1, wherein
the feature extractor and the image generator each have a structure to be changed in accordance with the sizes of the input inspection image.

9. The abnormality detection system according to claim 1, wherein
the inspection image is image of an electronic circuit.

10. A learning apparatus for learning a learning model that carries out abnormality detection of detecting a visual defect of an object,
the learning model including a feature extractor and an image generator,
the learning apparatus comprising:
an input unit that acquires training images including a non-defective image of a target object;
the feature extractor that extracts a feature map, based on the training images input to the input unit;
the image generator that generates restored image by restoring the training images from the feature map extracted by the feature extractor; and
a learning unit that updates parameters of the feature extractor and image generator, based on the training images and the restored images,
wherein
the training images input to the input unit have different image sizes each of which is equal to or more than a predetermined size.

11. The learning apparatus according to claim 10, wherein
the feature map extracted by the feature extractor has a size equal to or more than a size of 8 by 8 pixels.

12. The learning apparatus according to claim 11, wherein
on condition that the sizes of the training images are each indicated by M and the size of the feature map is indicated by N, the feature map extracted by the feature extractor satisfies the following formula (1):
N≥M×(½)\hat{ }^{a} Formula (1),
where M and N each represent a number of vertical or horizontal pixels, and a represents a number of convolution layers in the feature extractor.

13. The learning apparatus according to claim 10, wherein
the feature extractor extracts the feature map from which spatial information on an image is not lost.

14. The learning apparatus according to claim 13, wherein
the feature extractor does not include a fully connected layer or a global average pooling (GAP) layer.

15. An abnormality detection program for causing a computer to function as the abnormality detection system according to claim 1.

16. A learning program for causing a computer to function as the learning apparatus according to claim 10.
